(19) United States
(12) Patent Application Publication
(10) Pub. No.: US 2006/0225225 A1
(43) Pub. Date: Oct. 12, 2006

(54) Method and apparatus for altering the appearance of fabric

(76) Inventor: Brian Bushell, New York, NY (US)

Correspondence Address: GOTTLIEB RACKMAN & REISMAN PC, 270 MADISON AVENUE, 8TH FLOOR, NEW YORK, NY, 100160601, US

(21) Appl. No.: 11/372,955

(22) Filed: Mar. 10, 2006

Related U.S. Application Data
(60) Provisional application No. 60/662,774, filed on Mar. 17, 2005.
(60) Provisional application No. 60/663,863, filed on Mar. 21, 2005.

(51) Int. Cl. C11D 3/00

(52) U.S. Cl. 8/115.51

(57) ABSTRACT

A method and apparatus for altering the appearance of a section of fabric or garment to provide a naturally distressed and vintage appearance. The method includes providing a section of fabric having a contact area located on the exterior surface thereof and rubbing an abrading member across the surface of the fabric. In a preferred embodiment, the abrading member is comfortably fitted to the hands of a user and comprises a polyurethane foam block and an abrasive layer composed of a polyurethane elastomer and aluminum oxide particles. The apparatus may optionally include a rigid template or stencil positioned beneath the surface of the section of fabric which is abraded causing the shape of the stencil to be abraded on the outer surface of the fabric.

This application claims the priority date of U.S. provisional patent application Ser. No. 60/662,774 filed on Mar. 17, 2005 and U.S. provisional patent application Ser. No. 60/663,863 filed on Mar. 21, 2005, which are hereby incorporated herein by reference.

### FIELD OF THE INVENTION

This invention relates to a method and apparatus for altering the appearance of textiles. More specifically, this invention involves a method and apparatus for distressing the exterior of fabric. Even more specifically, this invention relates to a method and apparatus for providing an aged and vintage appearance to articles of clothing, such as denim jeans and other apparel, and a method and apparatus for placing visual indicia on fabric or apparel.

### BACKGROUND OF THE INVENTION

Throughout the modern era, fashion designers and consumers alike have been enamored with styles and appearances of years past. For instance, classic styles of the 1900s often reappear in contemporary fashions as well as home decorations. In their pursuit of creating fashionable styles of clothing and housewares as well as the fabric utilized in the creation of such stylish items, creators often tailor their designs to provide a naturally aged and vintage appearance.

In the context of denim apparel which may intermittently go out of fashion, but never completely out of style, many consumers nowadays decline to wear traditional blue denim for fear of being identified with their less-than-hip parents of the previous generation. While still desiring the overall comfort and look of denim, these individuals have turned to denim garments of different finishes, cuts and styles. Further, these individuals have turned their attention to aged, authentic, vintage denim apparel, typically purchased in secondhand stores and thrift shops, rather than conventional denim outlets. While appreciating or preferring the appearance of genuinely vintage apparel, many abstain from purchasing such items since they have previously been worn by other individuals.

Generally, in attempts to alter the appearance of fabric and garments, manufacturers and designers have resorted to a number of well-known processes such as acid washing, stone washing, blasting, rinsed washing, antique washing, dirty washing, enzyme and silicone washing, double dyeing, overdyeing and many others. In the context of denim fabric and apparel, many of these processes are simply intended to provide wholly different appearances that are distinct from the aged, vintage appearance that is desirable to consumers.

Further, while some of these processes are utilized to produce distressed and vintage-look fabric and apparel, many are simply insufficient since they tend to distress fabric in a conspicuously artificial manner that consumers recognize and find undesirable. For example, rough stones that are used by denim designers and manufacturers are not flexible and cannot contour to the natural shape that the apparel assumes when worn. Thus, the effects of the inflexible stones on the fabric are not particularly natural and consistent when compared to fabric that is distressed over time. In addition, due to the rough nature and shape of stones that are utilized to distress and abrade fabric and garments, it is often difficult and cumbersome to obtain a comfortable grip on the stones when manually rubbing them against the surface of a section of fabric.

Typically, in incorporating visual indicia, such as letters, numbers or shapes, on the surface of a garment, a designer or manufacturer is required to append a three-dimensional design accessory, such as a flower, or apply a layer of fabric paint in any number of possible designs or configurations for the purpose of making the garment more visually appealing. This may be limiting insofar as users often desire a more subtle look or one that is generally flat (i.e., two dimensional) or one that does not require the use of paint which may cause a mess.

### SUMMARY OF THE INVENTION

Accordingly, it is an object of the present invention to provide an improved method and apparatus for quickly and efficiently altering the appearance of fabric and garments to provide an aged and vintage appearance.

Another object of the present invention is to provide a method and apparatus for evenly and consistently distressing fabric and garments to alter their appearance.

Yet another object of the present invention is to provide a method and apparatus that incorporates micro-abrasives to evenly distress fabric and garments which provide a naturally aged and vintage appearance.

A further object of the present invention is to provide a method and apparatus for imparting visual indicia, such as letters, numbers and shapes, to the surface of a garment or section of fabric by distressing the exterior of a fabric or garment, and/or removing the dye off the fabric or garment, in the form of said indicia.

Still another object of the present invention is to provide an apparatus for distressing fabric and garments that is flexible, comfortable to grip and easy to use while abrading the surface of a section of fabric.

Additional objectives will be apparent from the description of the invention that follows.

In its broadest aspects, the invention involves a method and apparatus for altering the appearance of a section of fabric or garment. The fabric utilized may comprise cotton and cotton-poly blends or a number of other well-known conventional materials used in the formation of fabrics. The method and apparatus may also be used in conjunction with different forms of garments including denim apparel, shirts, pants, sweats and others. In conjunction with the apparatus described below, the invention is a method for distressing a section of fabric to give it an aged and vintage appearance. The method comprises the steps of providing an abrading member having an abrasive layer and providing a section of fabric having a contact area located on the exterior surface thereof. The abrasive layer passes across the contact area of the fabric with sufficient pressure to distress or deteriorate at least a portion of the exterior at the contact area. In conjunction with, or instead of, deteriorating at least a portion of the exterior of the contact area, the abrasive layer of the abrading member may remove the dye from the exterior of the fabric or garment.

In a preferred embodiment, the apparatus comprises an abrading member which includes a foam block or other flexible member having an abrasive coating on one side thereof that is capable of abrading fabric at a rapid pace to provide a naturally aged and vintage appearance. Preferably, the abrasive coating of the member comprises a durable polyurethane elastomer and aluminum oxide particles which together form a flexible and abrasive surface for distressing fabric. Further, the abrading member is comfortably fitted to the hand of a user for manually abrading a section of fabric.

The apparatus may further comprise a rigid pattern, template or stencil that is placed behind or beneath the surface of the section of fabric which is abraded. In doing so, the fabric is sandwiched between the stencil and abrading member. Accordingly, when the fabric is rubbed with the abrading member, the surface of the fabric wears more quickly in areas located opposite the stencil than in other areas of the fabric, thereby causing the shape or image of the stencil to be abraded on the outer surface of the fabric.

Optionally, a means for maintaining the stencil in a fixed location on or beneath a given area of a section of fabric or garment may be utilized as well. The means for maintaining may include an adhesive, reusable binding agent, fasteners, manually adjustable clamp and equivalents thereof.

### BRIEF DESCRIPTION OF THE DRAWINGS

FIG. 1 is a perspective view of a preferred embodiment of the abrading member of the present invention, having an abrasive layer and grip section;

FIG. 2 is a perspective view of a user applying the abrading member to a section of fabric;

FIG. 3 is an elevational view of a pair of jeans with designs abraded into the outer surface of the fabric thereof utilizing an abrading member and various stencils;

FIG. 4 is a perspective view an abrading member, a heart-shaped stencil and a section of the fabric prior to being distressed;

FIG. 5 is a section of fabric, a heart-shaped stencil positioned underneath the fabric and an abrading member applied to the fabric;

FIG. 6 is a view taken along line 6-6 of FIG. 5 of the abrading member, section of fabric and a heart-shaped stencil;

FIG. 7 is a perspective view of a section of fabric with the shape of a heart abraded into the fabric;

FIG. 8 is a section of fabric fastened between a hand-shaped stencil and clamp;

FIG. 9 is a view taken along line 9-9 of FIG. 8 of the section of fabric, hand-shaped stencil and clamp;

FIG. 10 is a section of fabric fastened between two rings with a heart-shaped stencil having a ridge positioned beneath the fabric; and

FIG. 11 is a view taken along line 11-11 of FIG. 10 of the section of fabric, two rings and heart-shaped stencil.

### DETAILED DESCRIPTION OF THE INVENTION

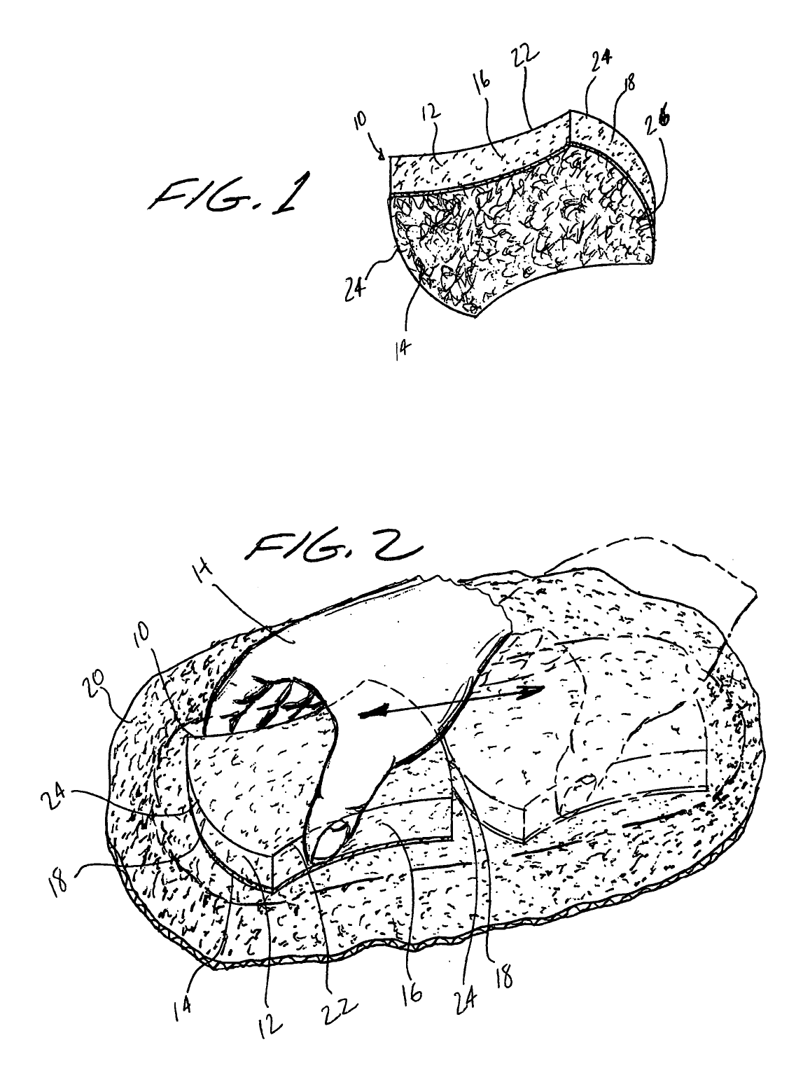

Referring to the drawings, FIGS. 1 and 2 depict a preferred embodiment of the abrading member or pad 10 used to alter the appearance of a section of fabric 20, giving it a naturally distressed and aged appearance. The abrading member 10 preferably comprises a flexible foam block 12 and an abrasive coating 14 applied to the foam block 12. The foam block 12 is preferably cut to a shape and size that is suitable for holding in the hand H of a user. In a preferred embodiment, the abrading member 10 is constructed of polyurethane foam with the dimensions of approximately four inches long, by approximately three inches wide, by approximately one inch in height. As shown in the figures, the foam block 12 is preferably pinched inwardly at two opposite sides, forming concave surfaces 16 at the lateral edges 22 of the foam block 12 against which the fingers of a user may rest when utilizing the abrading member 10. The foam block 12 also comprises two convex surfaces 18 at the ends 24 of the block 12. However, the convex surfaces 18 may be shaped to form concave surfaces instead, as at the lateral edges 22, if desired. Applying at least one convex or concave surface allows the abrading member 10 to gain increased access to and come in contact with hard-to-reach areas of a garment. Of course, the foam block 12 may be formed into any suitable shape. Further, other types of materials besides foam may be utilized in the construction of the abrading member 10, however, such materials should be somewhat flexible to conform to various shapes and contours to provide for natural and even wear of the fabric 20. The flexibility further allows the abrading member 10 to bend and reach small crevices like the ones along the seams of garments.

The abrasive coating 14 is made of a combination of elastomeric material and abrasive particles. The abrasive particles are embedded in and/or disposed upon the surface of the elastomeric material so that a sufficient number of abrasive particles capable of contacting and abrading the fabric 20. Many different types of elastomers may be used in connection with the formation of the abrasive coating 14, including nitrile, rubber, urethanes such as polyurethane, acrylics, epoxies, polyvinyl chlorides and butadiene rubber. The abrasive particles are preferably rigid and/or granular. Many different types of abrasive particles may be used alone or in combination with one another, including aluminum oxide, silicon carbide, alumina zirconia, diamond, ceria, cubic beron nitride, ganat, ground ceramic particles, ground plastics (i.e., polyvinyl chloride (PVC)), gromid glos and quartz. Significantly, the coating 14 conforms to the dimensions of at least the bottom surface 26 of the foam block 12. Preferably, the abrasive coating 14 is applied to the entire bottom surface 26 of the foam block 12, but may optionally be applied to only a portion thereof if desired. For example, the abrasive coating may be applied exclusively at the edges of the bottom surface of a foam block thereby forming a perimeter, or may be applied centrally to the bottom surface such that the edges have no abrasive coating. The abrasive coating may also be applied in a cross-cross pattern or in multiple other configurations. In forming the abrading member 10, the coated elastomer of the abrasive coating 14 is applied to the foam block 12 while the elastomer is in a liquid state. After it is applied, the elastomer hardens to form a resilient and abrasive surface on the bottom surface 24 of the foam block 12 in conjunction with the abrasive particles.

Optionally, the abrasive layer may be provided as a separate element that is not chemically bonded to the block section of the abrading member. In this embodiment, an abrasive layer such as sandpaper may be mechanically attached to the block section with conventional attaching means that are well known in the art such as clips, snaps or adhesive. After the abrasive layer and block are mechanically joined, pressure is applied to the block to deteriorate the exterior of the fabric or garment and/or remove the dye.

Although a preferred embodiment of the abrading member comprises a foam block or other flexible materials such as rubber, thermoplastic elastomers or steel wool pads, it should be understood that a generally rigid member may be utilized instead, independent of whether the abrasive layer is chemically or mechanically bonded to the block.

When running the abrading member 10 across the surface or any contact area of a piece of fabric 20 or garment where dye is applied, such as denim jeans, the abrading member 10 may be utilized to remove at least some of the applied dye by rubbing the abrading member 10 across the fabric or garment. In addition to removing the dye, the abrading member 10 abrades the external surface threads, eventually exposing the internal threads of the fabric or garment if sufficient pressure is applied and if used for a sufficient period of time. When running the abrading member across the surface of fabric or garments that are weaved before they are dyed (as opposed to items that are dyed before they are weaved), it provides for faster removal of the dye and clearer contrast between the dyed region(s) of the fabric and the portion(s) from which the dye was removed.

In order to provide the fabric or garment, such as a pair of jeans, with a more natural distressed and vintage appearance, it is preferable to rub the abrading member 10 along the grain of the fabric or garment, such as in a downward direction along the length of the legs of a pair of jeans. However, it should be understood that the abrading member 10 may still yield a desired result for some by rubbing it against or across the grain of the fabric 20 as well, so long as sufficient pressure is applied to deteriorate the exterior of the fabric or garment, or to remove the dye applied thereto. Furthermore, a more natural distressed and vintage appearance may be derived from using the abrading member 10 on a garment, such as along the legs of a pair of jeans or in other locations thereof, when the garment is worn. However, it should be understood that the abrading member 10 will still yield a desired result even the garment is not worn by a user when the abrading member 10 is utilized. When using the rigid template or stencil (discussed below), it is preferable not to wear the garment while utilizing the abrading member on the garment.

In another embodiment of the present invention, a patch comprising a section of fabric is provided in the form of a roll or sheet. Each patch includes a front and back side, where the back side is laminated with an iron-on adhesive or other suitable adhesive. On the front side of the patch, the user applies the abrading member to the fabric in order to abrade the fabric and/or remove the dye therefrom as is done in connection with other embodiments discussed herein. After completing work on the front side of the patch, a user then cuts out a segment of the patch to a desired shape or specification and applies it to a garment or other piece of fabric. A patch incorporating pre-cut segments of material or smaller individualized patches in a variety of shapes and sizes may be provided instead. Regardless of whether they are pre-cut or provided in relatively smaller sizes, the patches may be provided in roll or sheet form.

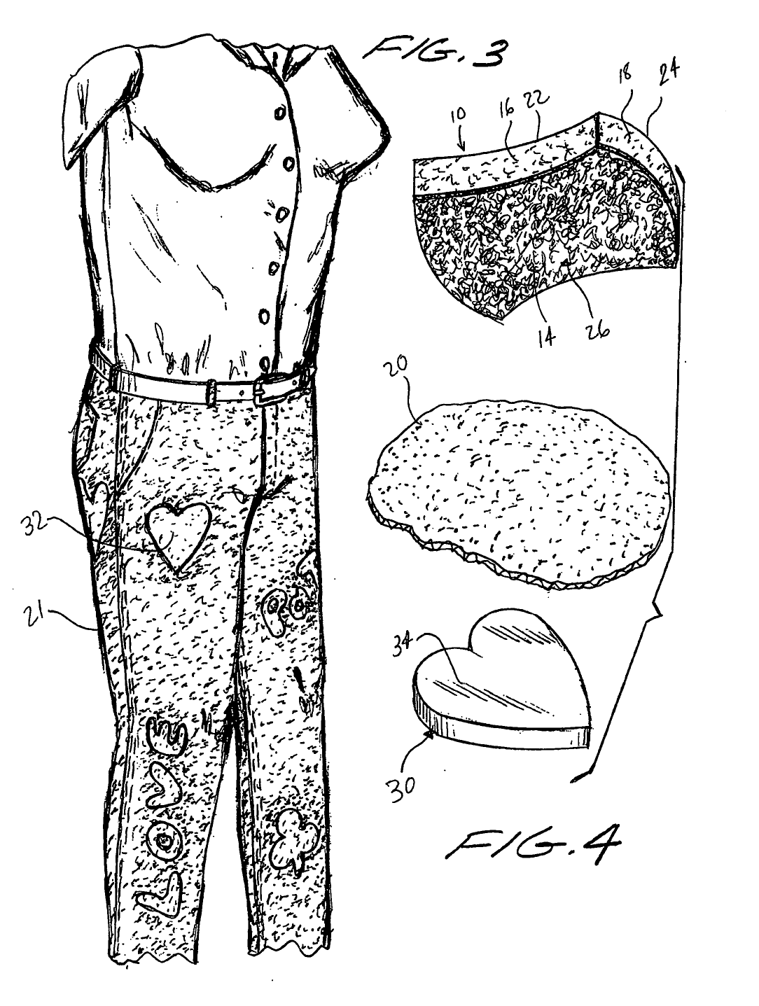

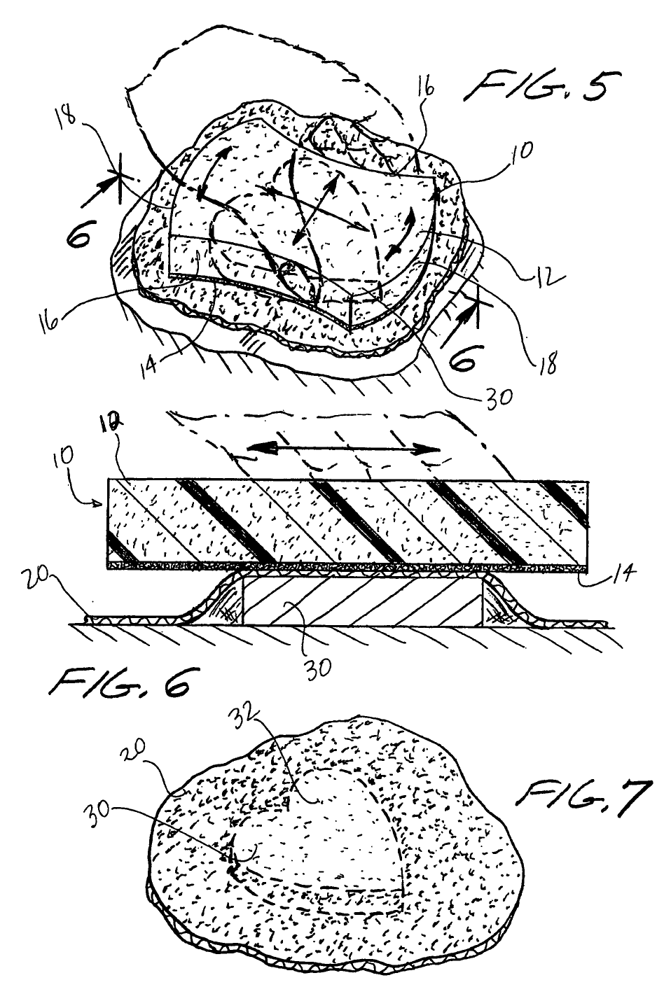

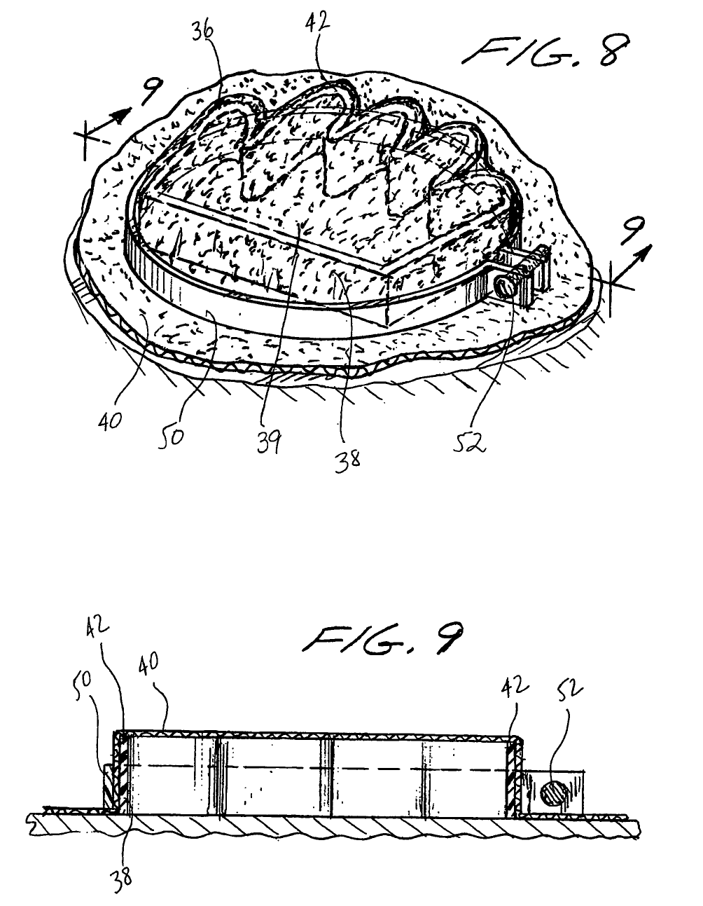

As shown in FIGS. 4 through 7, a rigid template or stencil 30 may be provided beneath the fabric 20 as the abrading member 10 abrades the fabric 20 and “sandwiches” the fabric 20 between the abrading member 10 and stencil 30. For garments such as pants, the stencil 30 may be positioned either interior of the garment (e.g., inside the pant leg) opposite the abrading member 10 where only one layer of the garment is between the stencil 30 and abrading member, or exterior of the garment opposite the abrading member 10 such that two layers of the garment are between the stencil 30 and abrading member 10. In either case, the stencil may be considered to be placed on a second side of the garment. In FIGS. 4 through 7, a heart-shaped stencil 30 is provided, however many different forms of stencils, including letters, words, numbers, shapes and designs may be provided in place of or in conjunction with the heart-shaped stencil 30 that is shown. When utilizing a heart-shaped stencil 30 in connection with the abrading member 10, the surface of the material comprising a garment, such as the jeans 21 shown in FIG. 3, wears more quickly during use of the abrading member 10 in an area 32 of the jeans 21 positioned directly above/opposite the raised surface or contact points 34 of the stencil 30, as compared to other areas of the material. This causes the shape of a heart to be abraded on the outer surface 32 of the denim garment as shown in FIG. 3. The contours of the stencil 30 cause the material to become more visibly abraded at location above the contact points 34, particularly at an area of material corresponding to the edges of the stencil 30.

It should be understood that as long as a sufficient amount pressure is applied to remove the dye with the abrading member 10 thereby producing a visible image in the general shape of the stencil 30, it may be undesirable to apply more pressure to the abrading member 10 or to use the abrading member for an extensive period of time since doing so may lead to tearing or fraying of the material or an undesirable degree thereof. In the context of using the abrading member 10 to provide a natural vintage appearance without use of a stencil 30, it may also be sufficient to simply apply enough pressure and to use the abrading member 10 for a limited amount of time in order to remove the dye of the fabric, rather than to tear or fray the fabric.

Stencils that incorporate a generally even upper surface on a relatively flat plane such are preferable, as in the heart-shaped stencil shown in FIG. 4, where the entire top surface 34 of the stencil 30 is flat and comes into uniform contact with the jeans 21. When stencils incorporate an upper surface with distinct peaks and valleys (i.e., non-uniform surface), there is an increased amount of pressure exerted on the material at the peaks causing those areas to wear and fade faster than at areas of the material opposite the valleys of the stencil.

It is also preferable to use stencils constructed of generally rigid material and which have flat back sides to allow the stencil to remain stationary on a table or flat surface. Depending on the shape and material of the respective stencil, they may be formed by cutting, molding, or extruding the material into a desired shape.

Stencils may optionally be coated at the side contacting the material with a pressure sensitive adhesive or temporary binding agent. The binding agent serves to hold the respective stencil in a desired location opposite the abrading member 10 when the exterior surface is rubbed. After the stencil is placed in its desired location, and the material is acted upon with the abrading member 10 and a desired effect is reached, the stencil is removed and can be reused later on.

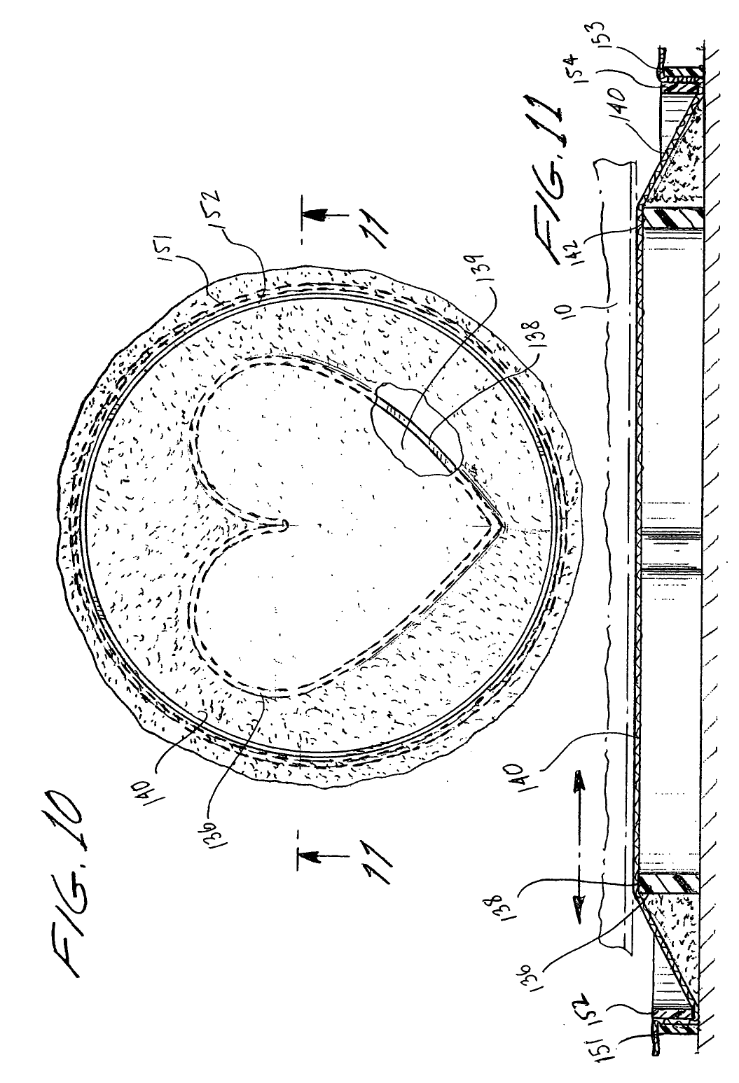

As shown in FIGS. 8 and 9, a hand-shaped stencil or template 36 is provided having an edge 38 that defines an interiorly located aperture 39. The template 36 and material 40 are held in place by a clamping apparatus 50 having a screw 52 that may be selectively tightened and loosened with a conventional tool. When utilizing the clamping apparatus 50, the material 40 is placed over the top and around the sides of template 36 and the clamping apparatus 50 fastens the material around the template 36 at the sides thereof. Instead of the screw shown in FIGS. 8 and 9, a tightening member that can be engaged by hand without the use of a tool may be provided to tighten and loosen the clamping apparatus 50. As a result of the aperture 39, the abrading member 10 causes more fading of the material 40 opposite the top portion 42 of the edge 38 that is positioned against the material as compared to the portion of the material 40 that is directly above the aperture 39.

As shown in FIGS. 10 and 11, a heart-shaped template 136 is provided having an edge 138 that defines an interiorly located aperture 139. In this embodiment, the material 140 is clamped and held tautly in place between a pair of generally rigid rings 151, 152. The rings 151,152, complement one another such that, the inner ring 152 has a diameter that is somewhat smaller than that of the outer ring 151 to allow the material 140 to fit snugly between the walls 153, 154 of the rings 151, 152, respectively. As shown in FIG. 11, when utilizing the rings 151, 152, the inner ring 152 is placed over the area or section of the material 140 that is being abraded, and the outer ring 151 secures the material 140 such that the material 140 is folded back in a generally vertical direction and held between the exterior surface of the wall 154 of the inner ring 152 and the interior surface of the wall 153 of the outer ring 151. After the material 140 is secured between the rings 151, 152, the template 136 is placed beneath the material 140 on a flat surface and the abrading member 10 is rubbed across the surface of the material 140. As with the embodiment shown in FIGS. 8 and 9, as a result of the aperture 139, the abrading member 10 causes more fading of the material 140 opposite the top portion 142 of the edge 138 that is positioned against the material as compared to the portion of the material 140 that is directly above the aperture 139.

Although the invention is described in terms of particular embodiments, it is to be understood that the embodiments are merely illustrative of an application of the principles of the invention. Numerous modifications may be made and other arrangements may be devised without departing from the spirit and scope of the invention. Furthermore, while some of the embodiments of the present invention are described in connection with fabric or sections thereof (i.e., not in connection with a finished garment) and others in connection with finished garments (i.e., jeans, shirts, pants etc.), it is to be understood that the invention generally applies equally and interchangeably to both and should be understood accordingly.

1. A method for altering the appearance of textiles comprising the steps of:
providing a textile having a surface;
providing a block of foam with a first side and a second side, said block of foam including an abrasive coating comprised of a coated elastomer and abrasive particles on said first side of said block;
contacting said abrasive coating with said textile; and
rubbing said first side of said foam block on said surface of said textile.

2. The method of claim 1, said coated elastomer selected from a group consisting essentially of nitrile, rubber, urethanes, acrylics, epoxies, polyvinyl chlorides and butadiene rubber.

3. The method of claim 1, said abrasive particles selected from a group consisting essentially of aluminum oxide, silicon carbide, alumina zirconia, diamond, ceria, cubic beron nitride, ganat, ceramic, plastic, gromid glos and quartz.

4. The method of claim 1, wherein said foam block is sized to fit in a hand of a user.

5. The method of claim 1, wherein said coated elastomer is applied to said block when said coated elastomer is in a liquid state and hardens to form a resilient and abrasive surface on said foam block in conjunction with said abrasive particles.

6. The method of claim 1, wherein said textile comprises a plurality of external threads and a plurality of internal threads and said rubbing step exposes said internal threads.

7. The method of claim 1, wherein said textile comprises a plurality of external threads and a plurality of internal threads and said rubbing step abrades said external threads.

8. The method of claim 1, said textile comprising a dye, wherein said rubbing step removes said dye from said textile.

9. The method of claim 1, wherein said rubbing step is along a grain of said textile.

10. A method for altering the appearance of a denim garment comprising the steps of:
providing a denim garment having a surface;
providing a block of foam with a first side and a second side, said block of foam including an abrasive coating comprising a polyurethane elastomer and particles of aluminum oxide on said first side of said block;
contacting said abrasive coating with said denim garment; and
rubbing said first side of said foam block on said surface of said denim garment.

11. The method of claim 10, wherein said polyurethane elastomer is applied to said block when said polyurethane elastomer in a liquid state and hardens to form a resilient and abrasive surface on said foam block in conjunction with said particles of aluminum oxide.

12. The method of claim 10, wherein said denim garment comprises a plurality of external threads and a plurality of internal threads and said rubbing step exposes said internal threads.

13. The method of claim 10, wherein said denim garment comprises a plurality of external threads and a plurality of internal threads and said rubbing step abrades said external threads.

14. The method of claim 10, said denim garment comprising a dye, wherein said rubbing step removes said dye from said denim garment.

15. The method of claim 10, wherein said rubbing step is along a grain of said denim garment.

16. A method for abrading a garment to alter its appearance comprising the steps of:
providing a garment having a contact area on an exterior of said garment;
providing a member having a surface with an abrasive layer disposed on said surface;
running said abrasive layer across said contact area of said garment with sufficient pressure to deteriorate at least a portion of said exterior of said garment at said contact area.

17. The method of claim 16, said member comprising an elastomeric material.

18. The method of claim 17, said member further comprising exposed rigid grains.

19. The method of claim 16, wherein said member is flexible.

20. The method of claim 16, said member comprising a foam block.

21. The method of claim 16, said member comprising rubber.

22. The method of claim 16, said member comprising a thermoplastic elastomer.

23. The method of claim 16, said member comprising a steel wool pad.

24. The method of claim 16, said member comprising an abrasive tool.

25. The method of claim 16, said abrasive layer comprising sandpaper.

26. The method of claim 16, wherein said running step is along a grain of said garment.

27. The method of claim 16, said member having a shape conforming to a contour of said garment when said garment is worn.

28. The method of claim 27, said shape being convex.

29. The method of claim 16, wherein said running step occurs when said garment is worn by a person.

30. The method of claim 16, wherein said garment is a pair of denim jeans having a leg and said running step further comprises running said member in a direction along said leg of said jeans.

31. The method of claim 16, wherein said direction is downward.

32. The method of claim 16, further comprising the steps of providing a rigid stencil and placing said stencil beneath said contact area of said garment prior to said running step.

33. A method for abrading a section of material to give it a worn appearance comprising the steps of:
providing a section of material having a first side and a second side opposite said first side;
providing a member having an abrasive surface;
providing a generally rigid pattern section having a contour;
positioning said pattern section at said second side of said section of material;
rubbing said first side with said member, whereby said contour of said pattern section is abraded onto said first side of said section of material.

34. The method of claim 33, said abrasive surface comprising granular particles.

35. The method of claim 33, said granular particles selected from a group consisting essentially of aluminum oxide, silicon carbide, alumina zirconia, diamond, ceria, cubic beron nitride, ganat, ceramic, plastic, gromid glos and quartz.

36. The method of claim 33, said member comprising a flexible material.

37. The method of claim 33, said member comprising a generally rigid material.

38. The method of claim 33, said member comprising foam.

39. The method of claim 33, said pattern section comprising a pressure sensitive adhesive for attaching to said section of material.

40. The method of claim 33, wherein said pattern section comprises a binding agent for temporarily attaching said pattern section to said second side of said section of material.

41. The method of claim 33, said positioning step further comprising means for maintaining said pattern section in a generally stationary position at said second side of said section of material.

42. The method of claim 33, said pattern section comprising a plurality of contact points and non-contact points, said contact points being in contact with said second side of said section of material and opposite said first side of said section of material.

43. The method of claim 42, wherein there is a greater amount of wear on said first side of said section of material opposite said contact points than opposite said non-contact points.

44. The method of claim 33, said pattern section comprising letters or numbers.

45. The method of claim 33, said pattern section comprising a shape.

46. An apparatus for abrading a garment comprising:
a flexible pad having an abrasive layer, said layer including an elastomeric material and granular particles;
wherein said pad is adapted to conform to a surface of said garment when said pad abrades said garment.

47. The apparatus of claim 46, said elastomeric material selected from a group consisting essentially of nitrile, rubber, urethanes, acrylics, epoxies, polyvinyl chlorides and butadiene rubber.

48. The apparatus of claim 46, said granular particles selected from a group consisting essentially of aluminum oxide, silicon carbide, alumina zirconia, diamond, ceria, cubic beron nitride, ganat, ceramic, plastic, gromid glos and quartz.

49. The apparatus of claim 46, further comprising a stencil having an outline and adapted to be positioned on a side of said garment opposite said pad, wherein when said pad abrades said garment an outline of said stencil is formed on said garment.

50. The apparatus of claim 46, further comprising a generally rigid template member adapted to be maintained in a stationary position on a side of said garment at a location opposing said pad when said pad abrades said garment.

51. The apparatus of claim 46, said garment comprising denim.

52. An apparatus for abrading a garment having an external contour and a surface comprising:
a flexible pad to manually rub said garment, said pad adapted to conform to said external contour of said garment against which said pad is rubbed;
an abrasive layer disposed on said pad, said layer comprising abrasive particles;
a template member, said template member adapted to be temporarily disposed beneath said surface of said garment when said flexible pad rubs said garment.

53. The apparatus of claim 52, wherein said garment is a pair of jeans.

54. The apparatus of claim 52, wherein said garment is a shirt.

55. The apparatus of claim 52, wherein said garment is a pair of pants.

56. The apparatus of claim 52, said garment comprising a dyed fabric.

57. A method for altering the appearance of an exterior of a garment comprising the steps of:
providing a patch having a front side and a back side opposite said front side, said back side of said patch comprising a laminated adhesive and said front side of said patch comprising dye;
providing an abrading member having an abrasive surface;
rubbing said front side of said patch with said abrading member, whereby at least a portion of said dye is removed from said front side; and
applying said back side of said patch to said exterior surface of said garment, wherein said patch adheres to said garment by said adhesive.
